(19) United States
(12) Patent Application Publication
(10) Pub. No.: US 2007/0145641 A1
(43) Pub. Date: Jun. 28, 2007

(54) INTERIOR VEHICLE TRIM PANEL HAVING COLORED DUAL DENSITY COMPOSITE SPRAY ELASTOMER SKIN AND SYSTEM AND METHOD FOR MAKING THE SAME

(75) Inventors: Joseph T. Donatti, Howell, MI (US); Ian S. Williams, Howell, MI (US); Nelson E. Williams JR., Saline, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/275,306

(22) Filed: Dec. 22, 2005

(51) Int. Cl. B28B 1/32

(52) U.S. Cl. 264/309

(57) ABSTRACT

The present invention relates a vehicle interior trim panel. In at least one embodiment, the panel may be made by providing a spray mold having a mold surface, spraying colored polyurethane material proximate the surface of the tool to form a colored polyurethane skin layer, and spraying expandable polyurethane material onto the skin layer to form a resilient layer on the colored polyurethane skin layer. The colored polyurethane skin layer and the resilient layer form a colored composite skin which can be removed from the tool and secured to a substrate to form a vehicle interior trim panel.

### BACKGROUND OF THE INVENTION

1. Field of the Invention

The invention relates to interior vehicle trim panels having colored dual density spray elastomer skin and system and method for making the same.

2. Background Art

The use of interior trim panels in automotive applications is relatively well known. One relatively typical vehicle interior trim panel comprises a relatively rigid substrate having a flexible thin plastic skin disposed over at least an interior facing portion of a surface of the substrate. Spraying material, such as a polyurethane composition, onto a mold provides a skin having several advantages. When a softer touch for the panel is desired, foam has been provided between the substrate and the skin. Prior vehicle parts and manufacturing methods are disclosed in U.S. Pat. Nos. 4,255,367, 5,071,683, 5,536,458, and U.S. Patent Application No. 2004/0247887, for example.

### BRIEF DESCRIPTION OF THE DRAWINGS

FIG. 1 is a schematic perspective view of an instrument panel according to the invention for use in motor vehicle;

FIG. 2 is a schematic cross sectional view of the panel taken along the line 2-2 of FIG. 1;

FIG. 3 is a schematic view of a spray tool and a spray assembly for use in forming the panel, wherein the spray assembly is shown applying material on the tool to form a colored skin layer of a composite skin;

FIG. 4 is a schematic view of the tool showing application of expandable material onto the skin layer to form a resilient layer of a composite skin; and

FIG. 5 is a schematic view of the composite skin spaced from a substrate between first and second mold portions of a mold and showing application of a foam material between the resilient layer and the substrate.

While exemplary embodiments in accordance with the invention are illustrated and disclosed, such disclosure should not be construed to limit the claims. It is anticipated that various modifications and alternative designs may be made without departing from the scope of the invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily of scale, some features may be exaggerated or minimized to show details of particular components. Therefore specific structural and functional details disclosed herein are not to be interpreted as limiting, but merely as a representative basis for the claims and/or a representative basis for teaching one skilled in the art to variously employ the present invention. Moreover, except where otherwise expressly indicated, all numerical quantities in this description and in the claims indicating amounts of materials or conditions of reactions and/or use are to be understood as modified by the word “about” in describing the broader scope of this invention. Practice within the numerical limits stated is generally preferred. Also, unless expressly stated to the contrary, percent “parts of,” and ratio values are by weight and the description of a group or class of materials as suitable preferred for a given purpose in connection with the invention implies that mixtures of any two or more members of the group or class may be equally suitable or preferred.

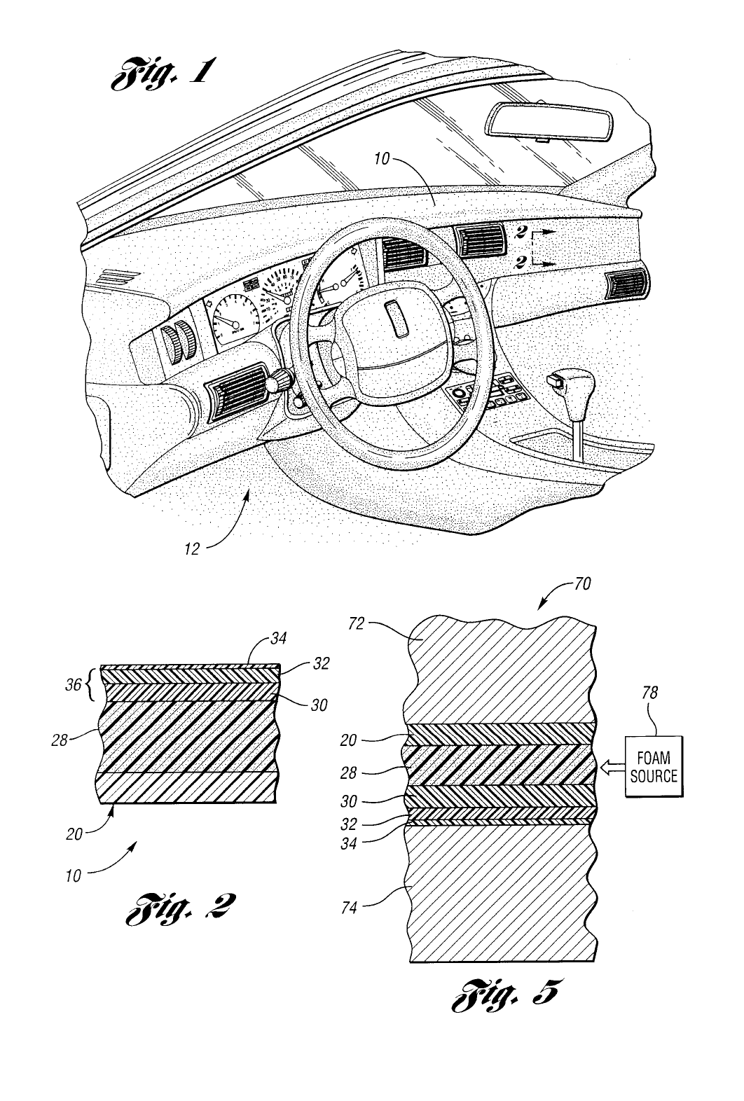

FIGS. 1 and 2 show an interior vehicle trim component, such as an instrument panel 10, according to at least one embodiment of the invention for use with a motor vehicle 12. In at least one embodiment, the panel 10 includes a rigid substrate 20, an optional foam layer 28 secured to the substrate 20, a resilient layer 30 secured to the foam layer 28, a colored skin layer 32 secured to the resilient layer 30, and an optional coating 34 that covers the skin layer 32 and provides an exterior apparent surface. The resilient layer 30 and the skin layer 32 comprise a colored composite skin 36.

The substrate 20 is a structural member that provides support for the remainder of the panel 10, and may comprise any suitable material. For example, the substrate 20 may be made of plastic or reinforced plastic such as fiberglass reinforced polyurethane. Additional examples of suitable plastics, besides polyurethane, include polypropylene, polyethylene, acrylonitrile butadiene styrene (ABS), polycarbonate (PC), ABS/PC blends, GRU and RRIM. The substrate 20 may be of any suitable thickness. In at least one embodiment, the substrate may have a general thickness of between 0.5 to 5 mm, in another embodiment 1.0 to 3.5 mm, and in yet another embodiment 2.0 to 3.0 mm.

The optional foam layer 28 is adhered between the substrate 20 and the resilient layer 30. If present, the foam layer 28 generally contours to the substrate 20 and helps to provide a soft feel to the instrument panel 10. If present, the foam layer 28 may comprise any suitable foam material. For example, the foam layer 28 may comprise a foam in place polyurethane foam. The foam layer 28 may be of any suitable density and any suitable thickness. In at least one embodiment, the density of the foam layer 28 is in the range of 0.05 to 0.20 grams per cubic centimeter (g/cm³). In at least one embodiment the foam layer 28 has a thickness of 3.0 to 25 mm, and in at least another embodiment 5 to 15 mm, and in yet another embodiment 8 to 12 mm.

In at least the embodiments illustrated in FIGS. 2 and 6, the resilient layer 30 is adhered to the foam layer 28 and the colored skin layer 32. It should be understood that in embodiments where the foam layer 28 is not present, the resilient layer 30 is adhered to the substrate 20 and the colored skin layer 32. The resilient layer 30 may help to provide a soft feel to the panel 10. The resilient layer 30 may comprise any suitable sprayed expanded polyurethane material. For example, the resilient layer 30 may comprise an expanded aromatic polyurethane elastomer.

In at least one embodiment, the density of the resilient layer 30 can be in the range of 0.1 to 0.75 g/cm³, in another embodiment between 0.15 to 0.5 g/cm³, and in yet another embodiment 0.2 to 0.3 g/cm³. In at least one embodiment, the resilient layer 30 may have a shore A hardness of 30 to 50. The resilient layer 30 may be any suitable thickness. In at least one embodiment, the resilient layer 30 may have a thickness between 0.1 and 30 mm and in at least another embodiment between 1 and 15 mm.

In at least one embodiment, the resilient layer 30 may primarily comprise a low permeable, relatively closed cell material. In at least one embodiment, the resilient layer 30 may comprise 35 to 75 percent closed cell structures, in at least another embodiment 40 to 65 percent closed cell structures, and in yet at least another embodiment 45 to 55 percent closed cell structures, based upon the entire resilient layer 30.

In at least one embodiment, the resilient layer 30 may have varying closed cell density throughout the resilient layer. In at least one embodiment, the top portion (the portion closer to the skin layer 32) and the lower portion (the portion closer to the foam layer 28) may independently comprise at least 85 percent closed cell structures, in other embodiments between 90 to 100 percent closed cell structures, and in yet other embodiments between 95 and 100 percent closed cell structures. In at least one embodiment, the top and bottom portions may independently comprise between 2.5 to 25 percent, in other embodiments between 5 to 20 percent, and in yet other embodiments between 10 to 15 percent, of the thickness of the resilient layer 30. The remaining intermediate layer (the portion between the top and bottom portion) of the resilient layer 30 may comprise between 40 to 95 percent closed cell structures, in at least another embodiment between 50 to 90 percent closed cell structures, and in yet another embodiment between 60 to 85 percent closed cell structures. In at least one embodiment, the average cell structure size can vary between 0.05 mm to 3.0 mm, and in yet other embodiment between 0.5 mm to 1.0 mm.

The colored skin layer 32 is adhered to the resilient layer 30 and, if present, the coating 34. Moreover, the skin layer 32 is configured to provide a covering over, and is generally contoured to, the resilient layer 30 and may comprise any sufficiently dense sprayed elastomeric polyurethane material. For example, the skin colored layer 32 may be a solid layer that comprises an aromatic or aliphatic compound. Furthermore, the colored skin layer 32 may have any suitable thickness and density. For example, the colored skin layer 32 may have a thickness in the range of 0.4 to 2 mm and a density in the range of 0.85 to 1.2 g/cm³. In at least one embodiment, the colored skin layer 32 has a thickness in the range of 0.5 to 1.2 mm, and a density in the range of 0.95 to 1.1 g/cm³.

In at least in one embodiment, the resilient layer 30 may have a color that would be aesthetically pleasing to a vehicle customer. In at least this embodiment, the skin layer 32 has a color that is substantially similar, or is the same, as the color of the resilient layer 30. This helps to prevent uneven coloration of the panel 10 if the skin layer 32 coverage is less than complete. Also, the resilient layer 30 may contain the same color, but in a lesser amount, or to a lesser degree, than the colored skin layer 32, to reduce material costs. Moreover, the resilient layer 30 may be a neutral color or the same color as the colored skin layer 32 depending upon the look the customer desires.

The optional coating 34 may be used to protect the colored skin layer 32 and/or to provide a particular decorative surface for the instrument panel 10. For example, the coating 34 may be used to inhibit sunlight and/or other ultraviolet light from reaching the skin layer 32. As another example, the coating 34 may be used as a paint to provide a desired color, gloss and/or texture to the instrument panel 10. While the coating 34 may comprise any suitable material, in at least one embodiment of the invention, the coating 34 is made of an aliphatic polyurethane composition. Furthermore, the coating 34 may have any suitable thickness, such as a thickness of approximately 0.2 to 2.0 mil.

Alternatively, the coating 34 may be omitted if not required for a particular application. For example, the colored skin layer 32 may be configured to provide a sufficiently durable and attractive surface such that the coating 34 is not needed. As such, if the coating 34 is not present either in whole or in part, the colored skin layer 32, and in areas of insufficient skin layer coverage, the resilient layer 30, may provide a desired color and/or texture to the instrument panel 10. For instance, if the colored skin layer 32 is scratched or cut, the resilient layer 30, being colored, could make the damage to the skin 32 less noticeable.

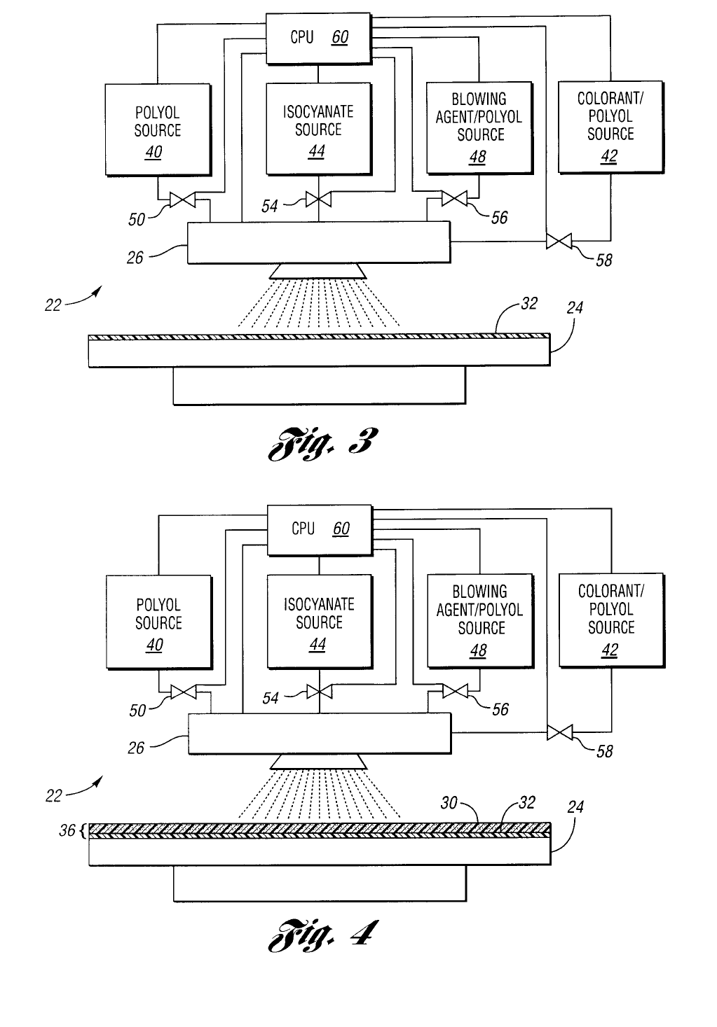

Referring to FIGS. 3-5, a method of manufacturing the instrument panel 10 will now be described. FIGS. 3-4 schematically illustrate a system 22 for manufacturing the colored composite skin 36. The illustrated system 22 generally comprises a spraying mold tool 24 having a spray receiving surface, generally corresponding to the surface of the panel 10, for receiving the polyurethane compositions and particularly the polyurethane composition for forming the colored skin layer 32. The system 22 further includes a spraying apparatus 26. Any suitable spraying apparatus, such as a robotic high pressure (such as 400 to 2,000 psi) spray apparatus having one or more movable spray nozzles, may be used. The spray apparatus 26 should also be capable of receiving at least four separate reactant streams. The tool 24 may be heated to any suitable temperature if desired, such as in the range of 150° C. to 165° C.

A liquid polyol source 40 is provided. Any suitable polyol or polyol blend can be used. One suitable polyol comprises 51840-01R available from BASF. In at least one embodiment, the polyol employed may be a polyether polyol. Examples of suitable liquid polyols, usable as the polyol source 40, include, but are not necessarily limited to, graft polyols, PhD polyols, polymer polyols, and PIPA polyols. The liquid polyol could have suitable additives, such as UV and antioxidant inhibitors/stabilizers.

A liquid isocyanate source 44 is provided. Any suitable liquid isocyanate, such as aromatic isocyanate, can be used. Examples of suitable aromatic liquid isocyanates include, but are not necessarily limited to, MDI and PDI. Alternatively, the liquid aliphatic isocyanate could also be used. The liquid isocyanate could have suitable additives such as UV inhibitors/stabilizers, especially if the liquid isocyanate is aromatic.

A liquid blowing agent/polyol source 48 is provided. The liquid blowing agent/polyol source 48 comprises a composition comprising a blend of liquid blowing agent and polyol. The liquid blowing agent/polyol source 48 could also contain catalyst, cell stablizers and surfactants. In at least one embodiment, the liquid blowing agent/polyol composition in the blowing agent/polyol source 48 can comprise 75 to 97.5 weight percent polyol and 2.5 to 25 weight percent liquid blowing agent.

In at least one embodiment, the liquid blowing agent comprises any suitable liquid blowing agent that will enable the liquid blowing agent and any, polyol and isocyanate to react to form the resilient expanded polyurethane layer 30 having a density of 0.1 to 0.75 g/cm³ and/or a shore A hardness of 30 to 50. In one embodiment, the liquid blowing agent comprises a delayed-action catalyst, water, or both. In one embodiment, the liquid blowing agent comprises a delayed-action catalyst and water. In one embodiment, a specific example of a delayed-action catalyst is the acid-blocked amine catalyst DABCO® BL-17 available from Air Products & Chemicals, Inc. of Allentown, Pa. In another embodiment, the amine catalyst DABCO® BL-22 can be employed. In yet another embodiment, the catalyst Bi-Cat No. 8, available from Shepard Chemical, can be employed.

A colorant/polyol source 42 is provided. The colorant/polyol source 42 comprises a composition comprising a blend of colorant and polyol. The liquid colorant could impart to the resultant urethane any suitable color, such as red, blue, black, etc. Any suitable liquid colorant can be used. Examples of suitable liquid colorants include, but are not necessarily limited to, finely ground (≦30 microns, such as 10 to 20 microns) pigment dispersed in a liquid component useable in the formation of polyurethane, such as polyol and/or isocyanate. Other suitable colorants, such as liquid dyes, can also be used. Suppliers of suitable colorants include Rite Systems of West Chicago, Ill. and PolyOne of North Baltimore, Ohio. In certain embodiments, the liquid colorant includes a UV stabilizer, such as zinc, benzophones, benzotriazole, and benzoxazione to inhibit UV degradation should the resultant polyurethane skin be exposed to UV light. Other suitable additives could be included, such as, but not necessarily limited to, triazines and radical scavengers, as are available from Ciba Specialty Chemicals and Cytec Polymers. In at least one embodiment, the colorant/polyol source composition in the colorant/polyol source 42 can comprise 75 to 97.5 weight percent polyol and 2.5 to 25 weight percent liquid colorant. If different color capabilities were desired, separate tanks (i.e., sources having polyol and different colors would be provided.

In at least one embodiment, the components in the polyol source 40, the isocyanate source 44, the blowing agent/polyol source 48, and the colorant/polyol source 42 are maintained at elevated temperatures, such as 70 to 125° F. and may be provided at a pressure between 400 to 2,000 psi to the spraying apparatus 26.

The method may begin by spraying an optional mold release agent and then the optional coating 34 on the spraying mold tool 24 using any suitable device, such as robotic low pressure (such as 10 to 40 psi) spray assembly having one or more moveable spray nozzles.

In at least one embodiment, the colored polyurethane skin layer 32 is made by first mixing a stream of polyol from the polyol source 40 with a stream of isocyanate from the isocyanate source 44 and a stream of colorant/polyol from the colorant/polyol source 42 to form a stream of colored polyurethane forming material (i.e., colored polyurethane composition) to be directed from the spraying apparatus 26 towards the spraying mold tool 24, as shown in FIG. 3.

In at least one embodiment, the colored polyurethane composition, prior to reacting, comprises 20 to 40 wt. % isocyanate, 50 to 75 wt. % polyol, and 5 to 15 wt. % colorant, based on the total weight of the colored polyurethane composition. In at least another embodiment, the colored polyurethane composition, prior to reacting, comprises 29.5% isocyanate, 63.5 wt. % polyol, and 7.0 wt. % colorant, based on the total weight of the colored polyurethane composition.

The colored polyurethane composition cures to form the colored skin layer 32 on the mold tool 24. In at least one embodiment, valves 50, 54 and 58 respectively are provided to enable control of the amount and speed of the polyol, isocyanate, and colorant provided to the spraying apparatus 26. While the valves 50, 54, 56 and 58 are schematically illustrated to be outside of the spraying apparatus 26, it should be understood that they could be, and in certain embodiments are, located within the spray head of the spraying apparatus 26.

Referring to FIG. 4, the method then involves introducing expandable material onto the colored skin layer 32 to form resilient layer 30, which bonds to the colored skin layer 32. In at least one embodiment, after the colored skin layer 32 has been formed, valve 58 is closed and valve 56 is opened to allow a stream of blowing agent/polyol to be delivered to the spraying apparatus 26. Valves 50 and 54 may also be manipulated at this time to alter (and/or stop) the flow of polyol and/or isocyanate being delivered to spraying apparatus 26 from their respective sources 40 and 44. CPU 60 can be provided to control the operation of the delivery of the components to, and the spraying of, the spraying apparatus 26.

In at least one embodiment, the polyol, isocyanate, and blowing agent mix in the spraying apparatus 26 to form an expandable polyurethane forming composition that is directed towards the colored skin layer 32, as is shown in FIG. 4. The expandable polyurethane material may comprise polyol, isocyanate and a blowing agent such as water and/or a readily volatile organic substance, such as a delayed-action amine catalyst. In at least one embodiment, the expandable polyurethane forming composition, prior to reacting, comprises 20 to 40 wt. % isocyanate, 50 to 75 wt. % polyol, and 5 to 15 wt. % blowing agent, based on the total weight of the expandable polyurethane forming composition. In at least another embodiment, the expandable polyurethane forming composition, prior to reacting, comprises 29.5 wt. % isocyanate, 63.5 wt. % polyol, and 7.0 wt. % blowing agent, based on the total weight of the expandable polyurethane composition. The expandable material may be allowed to free rise to achieve a desired density. The expandable polyurethane forming composition cures to form resilient layer 30 on colored skin layer 32.

In at least another embodiment, valve 58 remains open while valve 56 is opened to provide a colored expandable polyurethane forming composition that is directed towards the colored skin layer 32, which is allowed to form a colored resilient layer 30 on the colored skin layer 32. The colored expandable forming material, in at least this embodiment, can be a similar, or even the same, color to the color of the colored polyurethane forming material of the colored skin layer 32 such that the colored skin layer 32 and the resilient layer 30 are generally the same color. In this embodiment, the colored expandable polyurethane material may comprise polyol, isocyanate, colorant, and a blowing agent such as water and/or a readily volatile organic substance, such as a delayed-action amine catalyst. In at least one embodiment, the colored expandable polyurethane forming composition, prior to reacting, comprises 20 to 40 wt. % isocyanate, 45 to 70 wt. % polyol, 5 to 15 wt. % blowing agent, and 5 to 15 wt. % colorant, based on the total weight of the colored expandable polyurethane forming composition. In at least another embodiment, the colored expandable polyurethane forming composition, prior to reacting, comprises 29.5 wt. % isocyanate, 56.5 wt. % polyol, 7.0 wt. % blowing agent, and 7.0 wt. % colorant, based on the total weight of the colored expandable polyurethane forming composition.

As mentioned above, the coating 34 may be omitted from the panel 10. In such a case, the colored polyurethane composition may be sprayed directly onto the mold tool 24, or onto a mold release agent that is applied to the mold tool, to form the colored skin layer 32. In this embodiment, the colored skin layer 32 is preferably a colored aliphatic polyurethane.

Next, if a foam layer 28 is to be present, referring to FIG. 5, the method involves removing the optional coating 34, the skin layer 32 and the resilient layer 30, which comprises composite skin 36, from the mold tool 24 and positioning the composite skin 36 in a foam in place mold tool 70 having a first mold portion 72 and a second mold portion 74. At least one of the mold portions 72 and 74 are movable relative to the other. In particular, the composite skin 36 comprising the optional coating 34, the colored skin layer 32 and the resilient layer 30, in at least one embodiment, is provided on the second mold portion 74.

A substrate 20 may be suitably provided on the first mold portion 72 in a spaced apart relation from the composite skin 36. The mold portions 72 and 74 may then be closed together, and foam material can be injected at a relatively low pressure (such as 15 to 30 psi), from foam source 78, into the mold tool 70 through one or more injection passages (not shown) to form the foam layer 28, which bonds to the substrate 20 and the resilient layer 30. The instrument panel 10 may then be removed from the mold tool 70.

It should be noted that the foam layer 28 may be provided by any suitable means and not only by the foam in place process described above. For instance, the foam layer 28 can be glued or otherwise adhered between the substrate 20 and the composite skin 36. In embodiments where a foam layer 28 is not present, the composite skin 36 can be adhered or otherwise secured to a suitable substrate.

Examples of other vehicle parts that may be manufactured by the above method includes door panels, package shelves, pillar trim panels, trim products, door covers, console covers, shelves, and trim covers, among others.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for making a vehicle interior trim panel, said method comprising:
providing a spray mold having a mold surface;
spraying colored polyurethane material proximate the surface of the tool to form a colored polyurethane skin layer;
spraying expandable polyurethane material onto the skin layer to form a resilient layer on the colored polyurethane skin layer, the colored polyurethane skin layer and the resilient layer forming a colored composite skin;
removing the colored composite skin from the tool; and
securing a substrate to the colored composite skin to form a vehicle interior trim panel.

2. The method of claim 1 wherein the colored polyurethane material comprises a mixture of a stream of polyol, a stream of isocyanate, and a stream of colorant/polyol comprising a blend of colorant and polyol.

3. The method of claim 2 wherein the expanded polyurethane material comprises a mixture of a stream of polyol, a stream of isocyanate and a stream of blowing agent/polyol comprising a blend of liquid blowing agent and polyol.

4. The method of claim 3 wherein the resilient layer has a density of 0.1 to 0.75 g/cm³ and the skin layer has a density of 0.85 to 1.2 g/cm³.

5. The method of claim 1 wherein a layer of foam is provided between the colored composite skin and the substrate to secure the colored composite skin to the substrate.

6. The method of claim 1 wherein the colored polyurethane skin layer has a predetermined first color and the resilient layer has a predetermined second color substantially similar to the first color.

7. The method of the claim 6 wherein the expanded polyurethane material comprises a colored expanded polyurethane material comprising a mixture of a stream of polyol, a stream of isocyanate, a stream of blowing agent/polyol comprising a blend of liquid blowing agent and polyol, and a stream of colorant/polyol comprising a blend of colorant and polyol.

8. The method of claim 6 wherein the second color is the same as the first color.

9. A method for making a colored composite polyurethane skin, said method comprises:
providing a source of liquid polyol;
providing a source of liquid isocyanate;
providing a source of blowing agent/polyol comprising a blend of liquid blowing agent and polyol;
providing a source of colorant/polyol comprising a blend of colorant and polyol;
providing a spray mold tool having a mold surface;
providing a spraying device for spraying liquid material at the spray mold tool;
directing polyol, isocyanate and colorant/polyol to the spraying device to form a colored polyurethane composition;
spraying the colored polyurethane composition towards the spray mold tool to form a colored polyurethane skin layer on the spray mold tool;
directing polyol, isocyanate and blowing agent/polyol to the spraying device to form an expandable polyurethane composition; and
spraying the expandable polyurethane composition onto the colored polyurethane skin layer to form a resilient expanded polyurethane layer on the colored polyurethane skin layer.

10. The method of claim 9 wherein the resilient layer has a density of 0.1 to 0.75 g/cm³ and the skin layer has a density of 0.85 to 1.2 g/cm³.

11. The method of claim 9 wherein a layer of foam is provided between the colored composite skin and the substrate to secure the colored composite skin to the substrate.

12. The method of the claim 9 wherein the expanded polyurethane material comprises a colored expanded polyurethane material comprising a mixture of a stream of polyol, a stream of isocyanate, a stream of blowing agent/polyol comprising a blend of liquid blowing agent and polyol, and a stream of colorant/polyol comprising a blend of colorant and polyol.

13. The method of claim 12 wherein the colored polyurethane skin layer has a predetermined first color and the resilient layer has a predetermined second color substantially similar to the first color.

14. The method of claim 12 wherein the second color is the same as the first color.

15. The method of claim 9 wherein the colored polyurethane skin layer has an average thickness of 0.4 to 2.0 mm.

16. The method of claim 9 wherein the spraying device comprises a robotic spraying apparatus capable of spraying pressures of 400 to 2000 psi and capable of selectively receiving and controlling four separate reactant streams.

17. A system for making a colored composite polyurethane skin, system comprising:
a source of liquid polyol;
a source of liquid isocyanate;
a source of liquid blowing agent/polyol;
a source of colorant/polyol;
a spray mold tool having a mold surface; and
a spraying device for spraying liquid material at the spray mold tool;
the spraying device being able to receive polyol from the polyol source, isocyanate from the isocyanate source, and colorant/polyol from the colorant/polyol source to form a colored polyurethane composition for spraying towards the spray mold tool to form a colored polyurethane skin layer on the spray mold tool;
the spraying device being able to receive isocyanate from the isocyanate source, blowing agent/polyol from the blowing agent/polyol source, and polyol from the polyol source to form an expandable polyurethane composition for spraying onto the colored polyurethane skin layer to form a resilient expanded polyurethane layer on the colored skin layer.

18. The system of claim 17 wherein the resilient layer has a density of 0.1 to 0.75 g/cm³ and the skin layer has a density of 0.85 to 1.2 g/cm³.

19. The system of claim 17 wherein the colored polyurethane skin layer has a predetermined first color and the resilient layer has a predetermined second color substantially similar to the first color.

20. The system of the claim 19 wherein the expanded polyurethane composition comprises a colored expanded polyurethane material comprising a mixture of a stream of polyol, a stream of isocyanate, a stream of blowing agent/polyol comprising a blend of liquid blowing agent and polyol, and a stream of colorant/polyol comprising a blend of colorant and polyol.
